(19) United States
(12) Patent Application Publication
(10) Pub. No.: US 2024/0011332 A1
(43) Pub. Date: Jan. 11, 2024

(54) CUT RESISTANT PORTABLE LOCK APPARATUS

(71) Applicant: Schlage Lock Company LLC, Carmel, IN (US)

(72) Inventors: Carter Kemper, Quincy, MA (US); Brian E. Walls, Arlington, WA (US)

(21) Appl. No.: 17/859,451

(22) Filed: Jul. 7, 2022

(51) Int. Cl. E05B 67/06

(52) U.S. Cl. CPC E05B 67/063

(57) ABSTRACT

An exemplary portable lock apparatus generally includes a shackle and a crossbar. The crossbar includes a lock mechanism operable to selectively secure the shackle to the crossbar in a closed condition. The shackle includes a rigid shackle core and a cover layer covering at least a portion of the shackle core. The cover layer includes a ceramic material.

### TECHNICAL FIELD

The present disclosure generally relates to portable locks having features for resisting cutting of the shackle, and more particularly but not exclusively relates to such portable locks in which the shackle includes ceramic particles.

### BACKGROUND

Portable locks are often utilized to secure a relatively movable object, such as a bicycle, to a relatively stationary object, such as a bike rack. One common attack on such portable locks involves the use of a saw or grinder to cut through the shackle and thereby defeat the lock. Although certain existing shackles include features designed to resist such attacks, many of these solutions involve placing cut resistant materials in the core of the shackle, leaving the external surface of the shackle susceptible to attack by a saw or grinder. Additionally, the cut-resistant materials are typically brittle. As a result, once the external layer is defeated to expose the more-brittle core, the core may be snapped. For these reasons among others, there remains a need for further improvements in this technological field.

### SUMMARY

An exemplary portable lock apparatus generally includes a shackle and a crossbar. The crossbar includes a lock mechanism operable to selectively secure the shackle to the crossbar in a closed condition. The shackle includes a shackle core and a cover layer covering at least a portion of the shackle core. The cover layer includes a ceramic material. Further embodiments, forms, features, and aspects of the present application shall become apparent from the description and figures provided herewith.

### BRIEF DESCRIPTION OF THE FIGURES

FIG. 1 is a plan view of a lock apparatus according to certain embodiments.

FIG. 2 is a perspective view of a shackle according to certain embodiments.

FIG. 3 is an exploded assembly view of the shackle illustrated in FIG. 2.

FIG. 4 is a cutaway view of a portion of the shackle illustrated in FIG. 2.

FIG. 5 is a perspective view of a shackle according to certain embodiments.

FIG. 6 is a cutaway view of a portion of the shackle illustrated in FIG. 5.

FIG. 7 is a schematic flow diagram of a process according to certain embodiments.

FIG. 8 illustrates a shackle according to certain embodiments.

FIG. 9 is an enlarged view of a portion of the shackle illustrated in FIG. 6.

### DETAILED DESCRIPTION OF ILLUSTRATIVE EMBODIMENTS

Although the concepts of the present disclosure are susceptible to various modifications and alternative forms, specific embodiments have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. It should further be appreciated that although reference to a “preferred” component or feature may indicate the desirability of a particular component or feature with respect to an embodiment, the disclosure is not so limiting with respect to other embodiments, which may omit such a component or feature. Further, when a particular feature, structure, or characteristic is described in connection with an embodiment, it is submitted that it is within the knowledge of one skilled in the art to implement such feature, structure, or characteristic in connection with other embodiments whether or not explicitly described.

Additionally, it should be appreciated that items included in a list in the form of “at least one of A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C). Items listed in the form of “A, B, and/or C” can also mean (A); (B); (C); (A and B); (B and C); (A and C); or (A, B, and C). Further, with respect to the claims, the use of words and phrases such as “a,” “an,” “at least one,” and/or “at least one portion” should not be interpreted so as to be limiting to only one such element unless specifically stated to the contrary, and the use of phrases such as “at least a portion” and/or “a portion” should be interpreted as encompassing both embodiments including only a portion of such element and embodiments including the entirety of such element unless specifically stated to the contrary.

In the drawings, some structural or method features may be shown in certain specific arrangements and/or orderings. However, it should be appreciated that such specific arrangements and/or orderings may not necessarily be required. Rather, in some embodiments, such features may be arranged in a different manner and/or order than shown in the illustrative figures unless indicated to the contrary. Additionally, the inclusion of a structural or method feature in a particular figure is not meant to imply that such feature is required in all embodiments and, in some embodiments, may be omitted or may be combined with other features.

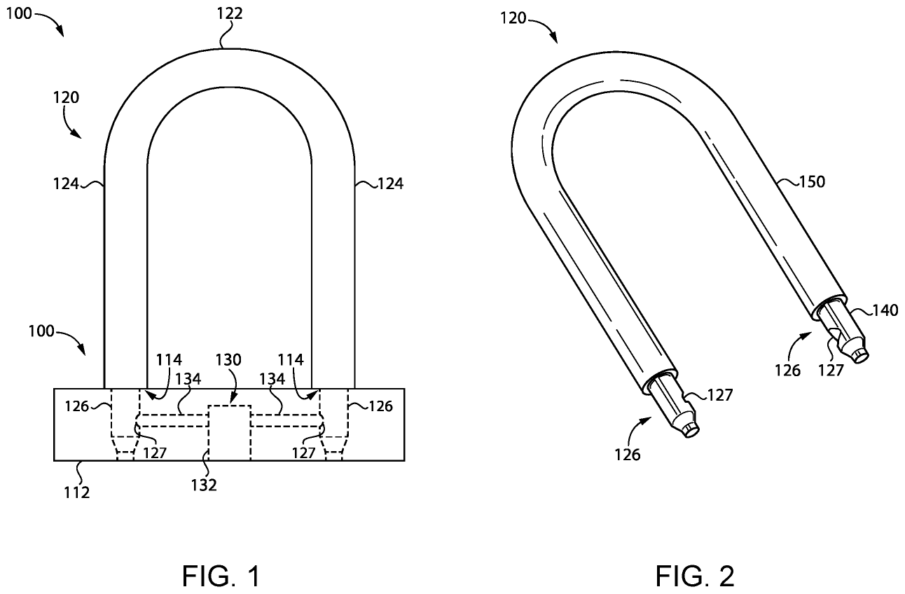

With reference to FIG. 1, illustrated therein is a portable lock apparatus 100 according to certain embodiments. The portable lock apparatus 100 generally includes a crossbar 110, a shackle 120, and a lock mechanism 130 operable to selectively secure the crossbar 110 and the shackle 120 in a closed condition.

The illustrated crossbar 110 generally includes a tubular body 112 having a pair of apertures 114 sized and shaped to receive feet 126 of the shackle 120. The lock mechanism 130 is positioned at least partially within the tubular body 112. In certain embodiments, the crossbar 110 may be considered to include the lock mechanism 130.

The illustrated shackle 120 generally includes an arcuate base portion 122, and a pair of legs 124 that extend from the base portion 122 to a pair of feet 126. At least one of the feet 126 includes a groove 127 sized and shaped to engage a bolt 134 of the lock mechanism 130, and in the illustrated form each foot 126 includes a corresponding and respective groove 127. In the illustrated embodiment, the feet 126 are parallel to one another. It is also contemplated that one of the feet 126 may be angled relative to the longitudinal axis of the corresponding leg 124.

The lock mechanism 130 is configured to selectively secure the crossbar 110 and the shackle 120 to one another in a closed condition. The lock mechanism 130 includes a lock core 132 and at least one bolt 134, and in the illustrated form includes a pair of bolts 134. The lock core 132 is operable to selectively retain at least one bolt 134 in an extended position in which the bolt 134 engages the groove 127 of a corresponding foot 126. The lock mechanism 130 has a locked state in which the lock mechanism 130 retains the lock apparatus 100 in a closed condition, and an unlocked state in which the shackle 120 is movable relative to the crossbar 110 to place the lock apparatus 100 in an open condition.

In certain forms, the lock core 132 may be provided in the form of a mechanical core. For example, the lock core 132 may include a key-operable lock cylinder and/or a mechanical combination lock. Additionally or alternatively, the lock core 132 may include electronic features that facilitate the transition of the lock mechanism 130 between its locked and unlocked states. For example, the lock core 132 may include a credential reader and/or a wireless communication device operable to communicate with an external device. A credential reader may, by way of illustration, include a biometric credential reader operable to read biometric credentials, a card reader operable to read a credential embodied in tangible form, and/or a keypad operable to receive credential input. A wireless communication device may, for example, be configured to communicate with an external device via Bluetooth (e.g., Bluetooth Low Energy), WiFi, Zigbee, and/or another wireless communication protocol.

In the illustrated embodiment, the crossbar 110 and the shackle 120 are separable from one another when the lock mechanism 130 is in its unlocked state. It is also contemplated that the crossbar 110 and the shackle 120 may remain coupled to one another when the lock apparatus 100 is in its open condition. By way of example, one foot 126 may be pivotably coupled to the crossbar 110 while the other foot 126 remains operable to enter and exit the crossbar 110 when the lock mechanism 130 is in its unlocked state.

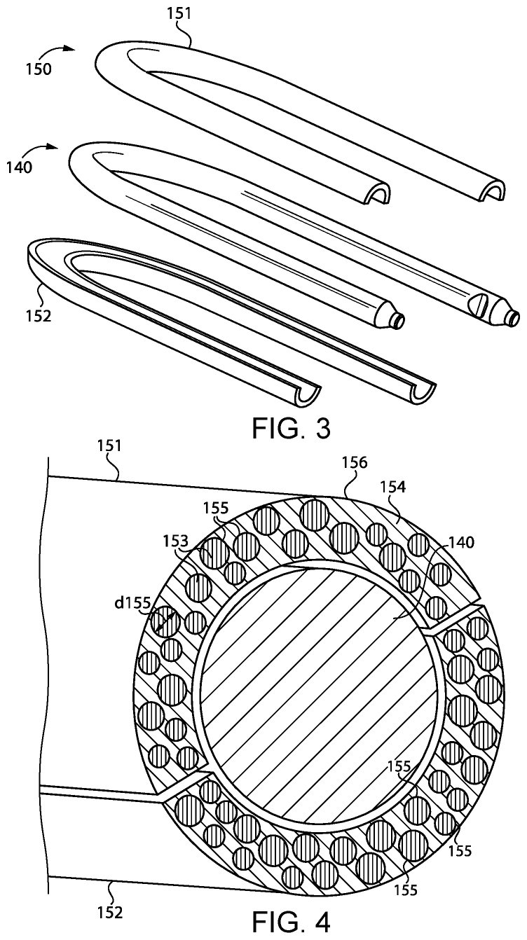

With additional reference to FIGS. 2 and 3, the shackle 120 generally includes an inner shackle core 140 and a cover layer 150 covering at least a portion of the shackle core 140. As described herein, the cover layer 150 covers at least a majority of the portion of the shackle 120 that is exposed when the shackle 120 is coupled to the crossbar 110, and protects the shackle core 140 from saw and/or grinder attacks.

The illustrated shackle core 140 is generally U-shaped, and includes the feet 126. In the illustrated form, the shackle core 140 is rigid, and may, for example, be formed of a metal material, such as steel. In certain embodiments, the shackle core 140 may be formed of a hardened material, such as hardened steel.

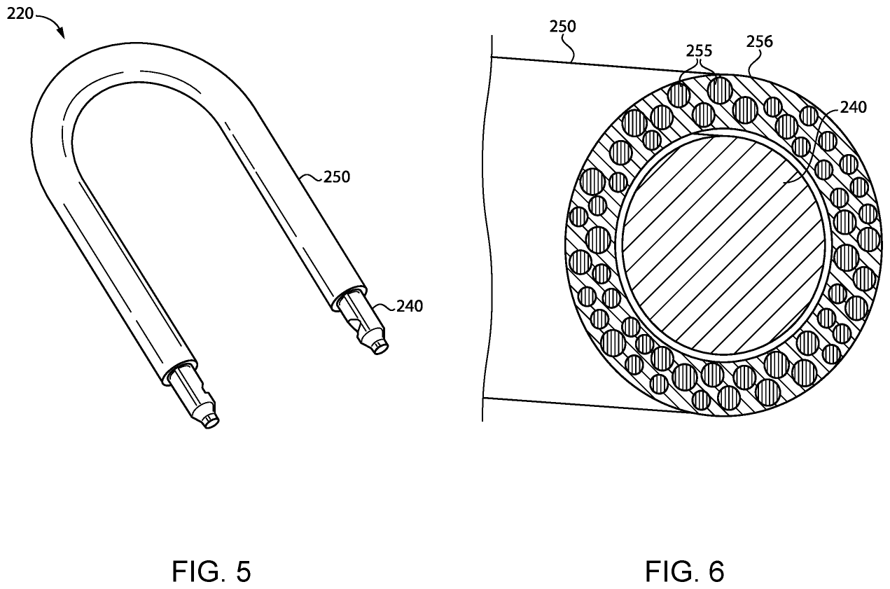

In the illustrated form, the cover layer 150 includes a first portion 151 covering a first side of the shackle core 140 and a second portion 152 covering an opposite second side of the shackle core 140. As described herein, the first portion 151 and/or the second portion 152 may be formed by casting. In certain embodiments, the cover layer 150 may be secured to the shackle core 140 via adhesive. It is also contemplated that the cover layer 150 may be secured to the shackle core 140 in another manner, such as by welding and/or brazing. While the illustrated cover layer 150 is formed of plural portions 151, 152, it is also contemplated that the cover layer 150 may be integrally formed as a single component, for example as described herein with reference to FIGS. 5 and 6. By way of illustration, the cover layer 150 may be over-molded onto the shackle core 140.

With additional reference to FIG. 4, the cover layer 150 may be formed of diverse materials. For example, the illustrated cover layer 150 includes a first material 153 and a second material 154 different from the first material 153. More particularly, the illustrated cover layer 150 includes a plurality of cut-resistant particles 155 formed of the first material 153, and a body 156 formed of the second material 154 such that the particles 155 are embedded in the body 156 and the second material 154 occupies the interstitial space between the particles 155. In the illustrated form, the first material 153 is a ceramic material, and the second material 154 is a metal material. The ceramic first material 153 may, for example, include alumina and/or zirconia. In certain embodiments, the ceramic material includes, but is not limited to, a crystalline or non-crystalline material, such as silicon carbide, boron oxide, silicon nitride, boron carbide, and/or tungsten carbide-cobalt. In certain embodiments, the cover layer 150 may be formed of composite materials having a ceramic matrix, such as embedded ceramic fibers. The metal second material 154 may, for example, include steel and/or zinc. It is also contemplated that the body 156 may be formed of a non-metallic material, such as a plastic material.

In the illustrated embodiment, the cut-resistant particles 155 are provided in the form of beads, which may have an average diameter d155 of one millimeter or greater. In certain embodiments, the average diameter d155 may be at least two millimeters, at least three millimeters, at least four millimeters, at least five millimeters, or at least one centimeter. It is also contemplated that the cut-resistant particles 155 may be provided as powder particles, for example having an average diameter d155 of less than one millimeter, or having an average diameter d155 of less than 100 microns. Moreover, while the illustrated particles 155 are generally spherical, it is also contemplated that at least some of the particles 155 may have one or more different geometries. In certain embodiments, an average maximum dimension of the particles 155 is three millimeters or less, or two millimeters or less.

In certain embodiments, the particles 155 may occupy at least 10% of the total volume of the cover layer 150, at least 25% of the total volume of the cover layer 150, at least 50% of the total volume of the cover layer 150, or at least 75% of the total volume of the cover layer 150. In certain embodiments, the second material 154 may occupy the balance of the volume of the cover layer 150. In certain embodiments, a third material may occupy at least a portion of the balance of the volume of the cover layer 150.

With additional reference to FIGS. 5 and 6, illustrated therein is a shackle 220 according to certain embodiments. The shackle 220 may, for example, be utilized in the lock apparatus 100 in place of the above-described shackle 120. The shackle 220 is substantially similar to the above-described shackle 120, and similar reference characters are used to indicate similar elements and features. For example, the shackle 220 includes a rigid shackle core 240 and a cover layer 250 covering at least a portion of the exposed portion of the shackle 220. In the interest of conciseness, the following description of the shackle 220 focuses primarily on elements and features different from those described above with reference to the shackle 120.

In contrast to the shackle 120, for which the cover layer 150 is formed of two portions 151, 152 that are secured to the shackle core 140, the cover layer 250 of the shackle 220 is integrally formed as a single-piece construction. In certain embodiments, the cover layer 250 may, for example, be over-molded onto an existing shackle core 240. In certain embodiments, the body portion 256 may be formed of a metal material, such as zinc or steel. The ceramic particles 255 may, for example, be of the type described above.

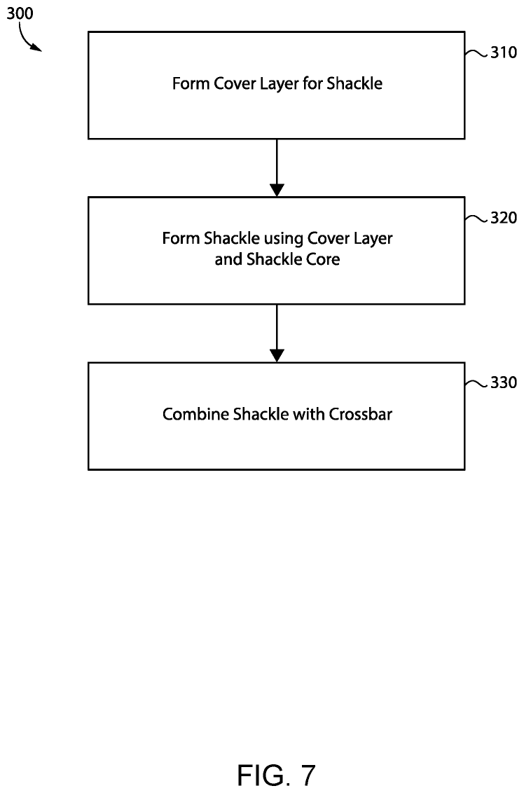

With additional reference to FIG. 7, illustrated therein is an exemplary process 300 that may be performed to manufacture the lock apparatus 100. Blocks illustrated for the processes in the present application are understood to be examples only, and blocks may be combined or divided, and added or removed, as well as re-ordered in whole or in part, unless explicitly stated to the contrary. Additionally, while the blocks are illustrated in a relatively serial fashion, it is to be understood that two or more of the blocks may be performed concurrently or in parallel with one another. Moreover, while the process 300 is described herein with specific reference to the portable lock apparatus 100 illustrated in FIGS. 1-4, it is to be appreciated that the process 300 may be performed to manufacture a lock apparatus having additional and/or alternative features.

The process 300 may include block 310, which generally involves forming a cover layer 150 for a shackle 120 of a lock apparatus 100. In certain embodiments, block 310 involves embedding a plurality of cut-resistant particles 155 in a body 156 of the cover layer 150. The cut resistant particles 155 are formed of a first material 153, and the body 156 is formed of a second material 154 different from the first material. In certain embodiments, the first material 153 comprises a ceramic material, and the second material 154 comprises a metal material. In certain embodiments, the ceramic material may comprise alumina and/or zirconia.

In certain embodiments, block 310 may involve mixing solid cut-resistant particles 155 with a liquid (e.g., molten) or semi-liquid second material 154. In certain forms, the particles 155 and the second material may first be mixed, and the mixture may be introduced to a mold to thereby mold or cast at least a portion of the cover layer 150. In certain forms, the particles 155 may be introduced to the mold prior to introduction of the second material 154. In certain forms, the second material 154 may be introduced to the mold prior to introduction of the particles 155.

The process 300 may include block 320, which generally involves forming a shackle 120, for example by securing the cover layer 150 to a shackle core 140. In certain embodiments, the cover layer 150 may include plural portions (e.g., a first portion 151 and a second portion 152), and block 320 may involve adhering, welding, brazing, or otherwise securing the plural portions to the shackle core 140. It is also contemplated that block 310 may be formed concurrently with block 320. For example, the cover layer 150 may be integrally formed as a single piece that surrounds at least a portion of the shackle core 140, such as by over-molding the cover layer 150 onto the shackle core 140.

The process 300 may include block 330, which generally involves combining the shackle 120 with a crossbar 110, the crossbar including a lock mechanism 130 operable to selectively secure the shackle 120 to the crossbar 110 in a closed condition. The lock mechanism 130 may, for example, include at least one bolt 134 and a core 132 operable to selectively retain the at least one bolt 134 in an extended position. In certain forms, the lock mechanism 130 may be a mechanical lock mechanism, such as one including a key-operated lock and/or a mechanical combination lock. In certain forms, the lock mechanism 130 may include electronic features, such as a credential reader and/or a wireless communication device.

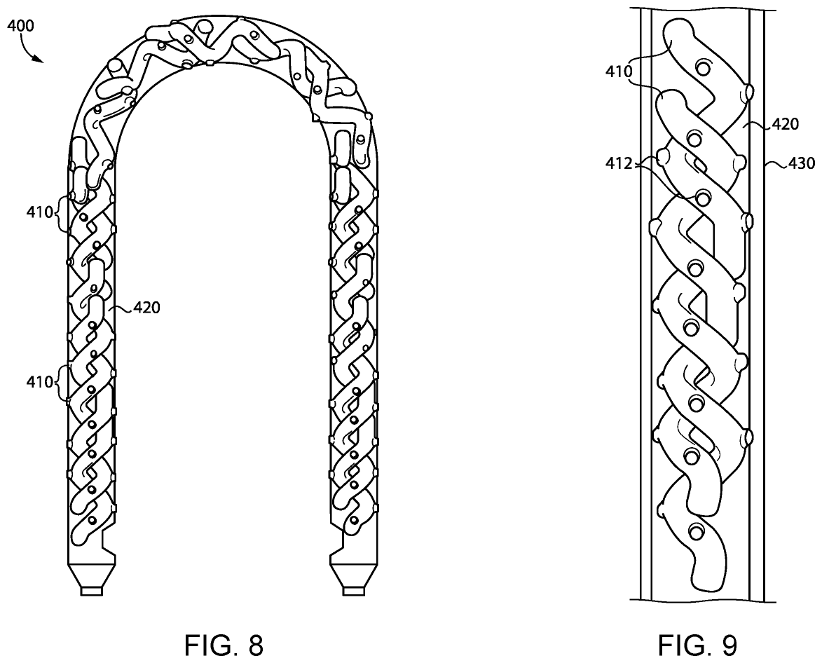

With additional reference to FIGS. 8 and 9, illustrated therein is a shackle 400 according to certain embodiments. The shackle 400 generally includes a plurality of helical structures 410 embedded in a shackle body 420, and may further include an outer layer 430. The shackle 400 may, for example, be utilized in a portable lock apparatus such as the portable lock apparatus 100. By way of example, the shackle 400 may be combined with a corresponding crossbar to form such a lock apparatus. While the illustrated shackle 400 is provided in a form intended to be separated from the crossbar, it is also contemplated that the shackle 400 may be provided in a form that remains coupled to the crossbar, for example via a hinged connection.

The helical structures 410 are generally helical, and are formed of a cut-resistant material. In certain embodiments, the helical structures 410 are formed of a ceramic material, such as alumina or zirconia. In the illustrated form, the helical structures 410 are intertwined with each other. In certain embodiments, the helical structures 410 include nubbins 412, which may aid in suspending the helical structures within a casting die, for example in embodiments in which the shackle 400 is cast. The helical structures 410 may, for example, be formed via an additive manufacturing process.

The shackle body 420 surrounds and at least partially encloses the helical structures 410 such that the helical structures 410 are embedded in the shackle body 420. The shackle body 420 may be formed of a metal material, such as a steel. In certain forms, the shackle body 420 may be cast in a die in which the helical structures have been placed such that the shackle body 420 surrounds the helical structures 410.

The outer layer 430 surrounds at least a portion of the shackle body 420, and provides a protective layer between the shackle body 420 and the items that will engage the shackle 400 to thereby protect both the shackle body 420 and the items from damage. The outer layer 430 may, for example, be formed of a plastic material and/or a rubber material.

Although certain embodiments discussed herein pertain to the type of lock apparatus known in the art as a U-lock, it is also contemplated that the concepts detailed herein may be utilized in connection with other forms of locks. As one example, a cover layer including ceramic particles may be provided to the shackle of a padlock. As another example, a cover layer including ceramic particles may be provided to the shackle of a ring lock.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected.

It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A portable lock apparatus, comprising:
a shackle; and
a crossbar comprising a lock mechanism operable to selectively secure the shackle to the crossbar in a closed condition;
wherein the shackle comprises:
a rigid shackle core; and
a cover layer covering at least a portion of the shackle core, wherein the cover layer comprises a ceramic material.

2. The portable lock apparatus of claim 1, wherein the cover layer comprises a plurality of discrete ceramic particles.

3. The portable lock apparatus of claim 3, wherein the cover layer further comprises a second material in which the plurality of ceramic particles are embedded.

4. The portable lock apparatus of claim 3, wherein the second material comprises metal. The portable lock apparatus of claim 3, wherein the ceramic particles comprise at least 50% of a total volume of the cover layer.

6. The portable lock apparatus of claim 1, wherein the shackle is separable from the crossbar when the lock mechanism is in an unlocked state.

7. The portable lock apparatus of claim 1, wherein the ceramic material comprises alumina and/or zirconia.

8. A method of manufacturing a lock apparatus, the method comprising:
forming a cover layer for a shackle of the lock apparatus, wherein forming the cover layer comprises embedding a plurality of cut-resistant particles in a body of the cover layer, wherein the cut resistant particles comprise a ceramic material, and wherein the body comprises another material different from the ceramic material; and
forming the shackle, wherein forming the shackle comprises securing the cover layer to a shackle core.

9. The method of claim 8, wherein the other material comprises a metal material. The method of claim 8, wherein the ceramic material comprises alumina and/or zirconia.

11. The method of claim 8, wherein the cut-resistant particles have an average dimension of one millimeter or greater.

12. The method of claim 8, further comprising combining the shackle with a crossbar, the crossbar comprising a lock mechanism operable to selectively secure the shackle to the crossbar in a closed condition.

13. The method of claim 8, wherein forming the cover layer comprises forming the cover layer in a mold or die.

14. The method of claim 8, wherein forming the cover layer comprises forming the cover layer in a plurality of pieces; and
wherein securing the cover layer to the shackle core comprises securing each of the plurality of pieces to the shackle core.

15. A portable lock apparatus, comprising:
a shackle; and
a crossbar comprising a lock mechanism operable to selectively engage a foot of the shackle to thereby prevent removal of the foot from the crossbar;
wherein the shackle comprises:
a shackle core; and
a cover layer covering at least a portion of the shackle core, wherein the cover layer comprises a body and a plurality of discrete ceramic particles embedded in the body.

16. The portable lock apparatus of claim 15, wherein the ceramic particles have an average diameter of one millimeter or greater.

17. The portable lock apparatus of claim 15, wherein the ceramic particles have an average diameter of one centimeter or less.

18. The portable lock apparatus of claim 15, wherein the body is formed of a metal material.

19. The portable lock apparatus of claim 15, wherein the ceramic particles comprise alumina and/or zirconia.

20. The portable lock apparatus of claim 15, wherein the ceramic particles comprise at least 50% of a total volume of the cover layer.
